(19) United States
(12) Patent Application Publication
(10) Pub. No.: US 2012/0202024 A1
(43) Pub. Date: Aug. 9, 2012

(54) Product Compositions, Product Walls, And Molding Processes

(76) Inventor: Vincent Paul Self, Kellogg, ID (US)

(21) Appl. No.: 13/369,194

(22) Filed: Feb. 8, 2012

Related U.S. Application Data
(60) Provisional application No. 61/440,823, filed on Feb. 8, 2011.

(51) Int. Cl. B32B 27/08; B29C 39/00; B32B 5/02; B32B 27/36; B32B 27/40

(52) U.S. Cl. 428/212; 428/480; 428/423.7; 442/401; 264/241

(57) ABSTRACT

Product compositions, product walls, and molding processes are described. According to one aspect, a product composition includes a polyester layer and an N-polymer layer coupled to the polyester layer.

### CROSS-REFERENCE TO RELATED APPLICATION

This application claims priority to U.S. Provisional Patent Application Ser. No. 61/440,823, which was filed on Feb. 8, 2011, entitled Fiberglass Barrier Layer and Methods, naming Vincent Paul Self as inventor, and which is incorporated herein by reference.

### TECHNICAL FIELD

This disclosure relates to product compositions, product walls, and molding processes.

### BACKGROUND OF THE DISCLOSURE

Fiberglass molding is a process which utilizes reinforcing fibers, such as silica-based fibers, and a resin to form useful shapes and products. For example, fiberglass molding may be utilized to manufacture hulls of marine vessels, parts of automobiles, home products (e.g., shower stalls), etc. In some processes, a finished exterior surface of the product may be desired and may provide an attractive outer surface with designs, graphics, colors, etc. However, during manufacture of various products, imperfections within underlying layers may be transferred through a fiberglass layer to the finished surface which may be unfortunately visible in the exterior surface of the product (e.g., the exterior hull of a marine vessel). In addition, some finished surfaces may be relatively hard and cracks within underlying layers and/or an exterior layer may also be transferred to or migrate within the finished layer resulting in visible cracks or imperfections within the exterior surface.

### BRIEF DESCRIPTION OF THE DRAWINGS

Exemplary embodiments of the disclosure are described below with reference to the following accompanying drawings.

FIG. 1 is an illustrative representation of a marine vessel according to one embodiment.

FIG. 2 is an illustrative representation of a fragment of a product being manufactured according to one embodiment.

FIG. 3 is an illustrative representation of a fragment of another product being manufactured according to one embodiment.

FIGS. 4A-4F are illustrative representations of acts of a process of forming a product according to one embodiment.

### DETAILED DESCRIPTION OF THE DISCLOSURE

At least some aspects of the disclosure are directed to manufactured products and methods of manufacturing products and some product manufacturing methods disclosed herein include manufacturing processes which utilize a mold. In one embodiment of the disclosure discussed in detail below, a barrier layer may be utilized to reduce the presence of imperfections, chips or cracks in the exterior surfaces of the manufactured products compared with products where no barrier layer is utilized. For example, the barrier layer may be provided between an exterior surface of the product and underlying layers of the product being manufactured and the barrier layer may be configured to reduce the presence of imperfections in the exterior layer or surface of the product resulting from imperfections within the underlying layers and/or imperfections within the exterior layer itself. In another example, the barrier layer may reduce the transfer of cracks or imperfections to the exterior layer or surface of the product from cracks in the underlying layers of the product and/or reduce the migration of cracks or chips in the exterior layer or surface of the product. Additional aspects and embodiments of the disclosure are discussed in detail below.

According to one embodiment, a product composition comprises a polyester layer and an N-polymer layer coupled to the polyester layer.

According to an additional embodiment, a product wall comprises a gel coat layer, a fiber-reinforced layer, and a barrier layer intermediate the gel coat layer and the fiber-reinforced layer.

According to another embodiment, a molding process comprises forming an exterior finish layer within a mold, forming a barrier layer over the exterior finish layer within the mold, and forming a structural layer over the barrier layer within the mold.

Products manufactured in accordance with example embodiments of the disclosure may be utilized in various industries or applications and may include finished products or products which may be assembled with other components to form finished products. Some of the aspects of the disclosure are directed towards manufacture of fiber-reinforced products such as fiberglass products. Example products which may be fabricated using methods of the disclosure include marine vessels, automotive panels or parts, shower stalls, and wind turbine blades. These products are merely examples and additional and different products for use in different industries may also be fabricated. In more specific examples, one or more walls of the products may be manufactured using example methods discussed herein.

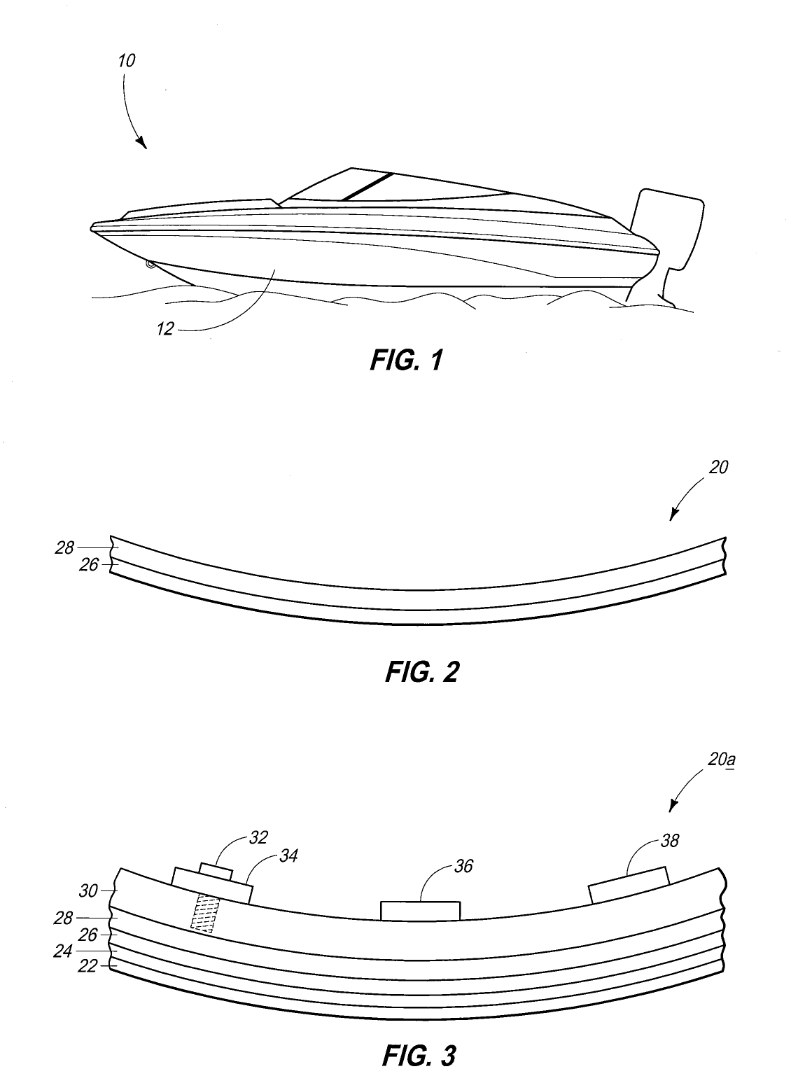

As mentioned above, molds may be utilized to manufacture products in accordance with some methods of the disclosure. For example, referring to FIG. 1, a mold (not shown in FIG. 1) may be utilized to fabricate a hull 12 of a marine vessel 10. In one embodiment, the hull 12 may be fiber-reinforced, for example including one or more fiberglass layer. Other components such as a motor, windshield, decking, etc. of the marine vessel 10 may be bolted or otherwise connected with the hull 12. The hull 12 of the marine vessel 10 of FIG. 1 is merely an example and other products may be manufactured using the methods disclosed herein.

Referring to FIG. 2, a fragment 20 of a wall of a manufactured product is shown in one example. The wall fragment 20 is a composition including a first layer 26 and a second layer 28 which may be manufactured using a mold (not shown in FIG. 2). In some embodiments, the first layer 26 may be an exterior layer of the wall of the product and may include a finished exterior surface for attractive outward appearance of the product in some embodiments. For example, in a marine vessel example, the first layer may be a gel coat with a desired colorant, graphics, etc. for the marine vessel.

As described in additional detail below, the second layer 28 may be a barrier layer. In one more specific embodiment, the barrier layer 28 may protect the first layer 26 during the fabrication of the product. In some methods described below, the first layer 26 of a product may be sprayed into a mold and subsequently formed layers may thereafter be formed or applied in these example methods (e.g., structural layers described below). However, the subsequently formed layers and/or addition of other components of the product may result in print transfer of images of the underlying layers to the first layer 26 which may be undesirable when the first layer 26 is utilized as a finished exterior layer. For example, in some manufacturing methods, reinforcing fibers may be utilized for structural rigidity in underlying structural layers but a pattern of the reinforcing fibers of these underlying layers may be transferred to the first layer 26 which may degrade the outward appearance of the product. Furthermore, bracing or structural support members may be utilized in the product and the presence of these members may also result in imperfections such as cracks or chips in the first layer 26. In some more specific embodiments, the first layer 26 may be relatively hard, such as a gel coat of a marine vessel, and marine hardware may be secured to the product using fasteners such as screws, rivets, bolts or other fastening devices which may result in cracking or chipping in one or more layers of the product and which may be transferred to or migrate within the first layer 26 of the product again perhaps degrading from the outward appearance of the product. The barrier layer 26 is provided in one embodiment to reduce the transfer to and/or migration of imperfections within the first layer 26 compared with arrangements which do not utilize a barrier layer.

In one embodiment, the first and second layers 26, 28 have different compositions with different characteristics. In some arrangements, the first layer 26 may be relatively hard and the second layer 28 may be selected to have less hardness compared with the first layer 26 and greater flexibility and elongation than the first layer 26 to reduce the transfer of features of subsequently-formed underlying layers to the first layer 26 and/or reduce or mitigate cracking or chipping in the first layer 26 resulting from cracks in the subsequently-formed underlying layers or during affixation of hardware or components to the first layer 26 by fasteners. In other embodiments, the second layer 28 may have substantially the same or greater hardness than layer 26 as well as subsequently formed layers 30 described below. In one more specific embodiment, the first layer 26 may be a polyester layer and the second layer 28 may be an N-polymer layer coupled to the first layer 26. Additional details of compositions of the first and second layers 26, 28 are discussed with respect to additional example embodiments below.

Referring to FIG. 3, a fragment 20a of a wall of a manufactured product is shown. The fragment 20a may correspond to the fragment 20 of the product of FIG. 2 with additional layers described below, or to an entirely different product.

As discussed above, some embodiments are described with respect to the manufacture of products using a mold 22 or which may also be referred to as a shell. In an example fabrication process, the mold 22 corresponds to a negative or inverse of the product to be manufactured or fabricated. Following the fabrication of the product using the mold 22, the product may be removed from the mold 22 and the mold 22 may be utilized to fabricate additional products in some manufacturing methods, discarded, recycled, etc. In the presently described example, the product being manufactured is a fiberglass hull of a marine vessel and the mold 22 is an inverse of the hull of the marine vessel being fabricated.

In the described embodiment, a release agent 24 is provided to an interior surface of the mold 22 to assist with the separation of a manufactured product from the mold 22. Thereafter, the first layer 26 may be applied over the release agent 24 within the mold. In the example of a marine hull, the first layer 26 may be a gel coat layer for the marine hull. The second layer 28 may be next applied into the mold 22 over the first layer 26. The second layer 28 may be a barrier layer having a different composition and different characteristics than the first layer 26 as described previously. The second layer 28 may have different characteristics than the first layer 26, for example, the second layer 28 may a lower harness than the first layer 26 and have increased elongation and flexibility characteristics.

One or more additional layers 30 may be formed upon the second layer 28. In the described marine hull example, third layer(s) 30 may be referred to as structural layer(s) which may be composite materials in the form of fiber-reinforced layer(s), such as fiberglass, and which may be provided upon the second layer 28 to provide rigidity to the product being manufactured. Other types of structural layers 30 may be utilized. In but one other alternative example, one or more structural layer 30 of a product may include a cloth or fabric, such as Gore-Tex® cloth from W.L. Gore & Associates, Inc. A polyester resin may be applied to the cloth or fabric to form a structural layer 30 in one illustrative example. Referring to the marine hull example product, a cloth or fabric structural layer 30 may be utilized in areas of the cockpit, instrument gauge clusters, glove box, etc.

In addition, other components, such as hardware, support members, frame members, or brace members may also be utilized. For example, a bolt 32 may be drilled into the third layer 30 with an associated bolt plate 34 and one or more brace members 36, 38 (e.g., polystyrene and/or wood brace members) may be affixed to and/or encapsulated within one or more third layer 30.

As discussed above, the utilization of the second layer 28 may reduce the transfer of images from other layers (e.g., fiber-reinforced layers) or migration of cracks or chips from other components (e.g., hardware, braces, frame members) of the product to or within the first layer 26 which may be an exterior layer including a finished exterior surface of the product in some embodiments.

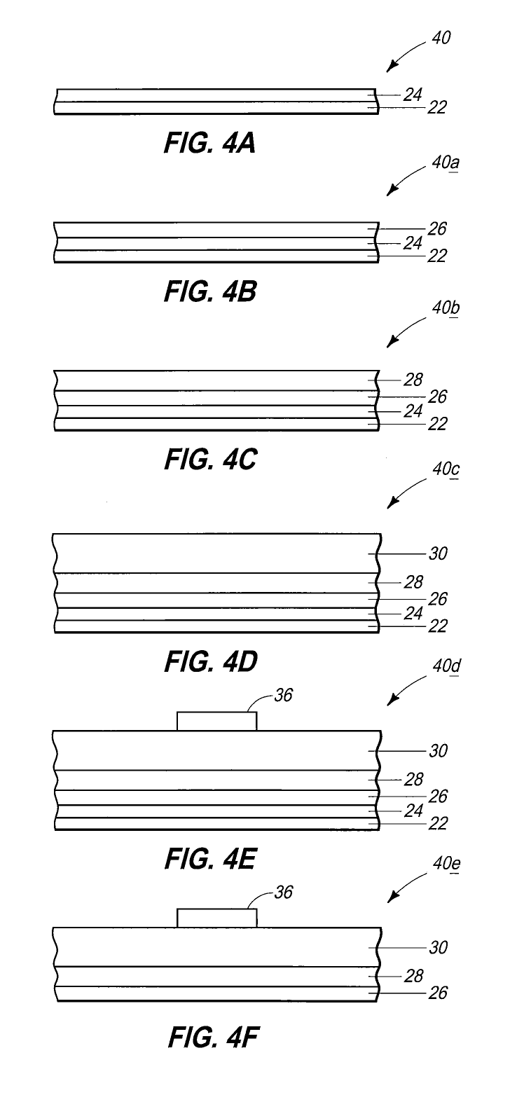

Referring to FIGS. 4A-4F, a method is described for manufacturing a product according to one example embodiment. The example embodiment is described with respect to fabrication of a fiber-reinforced product, for example a fiberglass product such as a marine hull of a marine vessel in one specific embodiment. Other methods including more, less and/or alternative acts may be utilized.

In FIG. 4A, a wall of a product fragment 40 is shown in an initial processing stage where a mold 22 may be prepared for the manufacture of a product. For example, the interior surface of the mold 22 may be cleaned, debris from a previous manufactured product removed, and otherwise checked to be free of contaminants. Following the appropriate preparation of the mold 22, a release agent 24 is applied to the interior surface of the mold 22. A release agent 24 may be applied by any appropriate method to the interior surface of the mold 22, such as spraying or painting. Mold releases that may be utilized include but are not limited to, substantially hydrocarbon based products, such as those products that contain heptanes, halogens, such as difluoroethane, and/or ethers such as dimethyl ether. An example release agent 24 which may be used is Sprayon® General Purpose Mold Release available from Sherwin-Williams®.

In FIG. 4B, the first layer 26 may be applied over the release agent 24. The first layer 26 becomes an integral part of the finished laminate of the product in this embodiment. In some products, the first layer 26 is an exterior, finished layer of the outside of the product which provides an attractive exterior surface appearance. In but one marine hull product example, the first layer 26 may be a quick-setting, high-build, chemical resistant, thixotropic polyester coating such as a gel coat which is a polyester resin that protects and seals the subsequently-formed layers, such as one or more fiber-reinforced layer, from the elements including water, moisture and the sun's ultraviolet rays. As discussed above, a gel coat layer may provide the hull with its color and provide a glossy finish, similar to paint on an automobile.

First layer 26 can be a substantially polyester layer. This polyester layer can be substantially carbon based and may be in the form of a polymer or a resin. The polyester can contain monomers or oligomers that include a carbon ester (—(C═O)—O—) functional group. These can be thermoplastic or thermoset polyesters. An example polyester or suitable gel coat can be Hybrathan gel coats available from Sogel Inc. of Quebec, Canada, for example.

In FIG. 4C, the second layer 28 may be applied over the first layer 26 and the second layer 28 may also be part of the finished laminate of the product. In the above-described example, the first layer 26 may be a polyester gel coat layer, and as discussed above, the second layer 28 may be a barrier layer having a different composition than the first layer 26 (and perhaps subsequent layers 30 if included) as well as different characteristics compared with the layers 26, 30 (e.g., increased flexibility, reduced hardness, increased elongation) which operate to reduce or obstruct the transfer of features or imperfections in subsequent layers 30 to the first layer as well as absorb energy of cracks or chips in the layers 26, 30 resulting in the presence of reduced imperfections in the first layer 26 compared with arrangements wherein barrier layer 28 is not utilized. In some embodiments, the second layer 28 has a thickness of approximately 10-50 mils. It is desired to achieve monolithic cross-linking of the first and second layers 26, 28 for a structurally-sound finished product. The use of the example gel coats described above assist with providing cross-linking to the second layer 28 which may be a polyurea layer, polyurethane layer, or polyurea/polyurethane hybrid in example embodiments. In example embodiments, the first and second layers 26, 28 may be one or both of physically and chemically bonded with one another.

In one embodiment, the second layer 28 is a polyurea coating/elastomer that is derived from the reaction product of an isocyanate component and a resin blend component. The isocyanate can be aromatic or aliphatic in nature and can be a monomer, polymer, or any variant reaction of isocyanates, quasi-prepolymer or a prepolymer in example embodiments. The prepolymer, or quasi-prepolymer, can be made of an amine-terminated polymer resin, or a hydroxyl-terminated polymer resin in illustrative implementations. The resin blend may include amine-terminated polymer resins, and/or amine-terminated chain extenders and the amine-terminated polymer resins may be void of any intentional hydroxyl moieties in some embodiments. Any hydroxyls are the result of incomplete conversion to the amine-terminated polymer resins in one example. The resin blend may also contain additives, or non-primary components in some embodiments. Illustrative additives include hydroxyls, such as pre-dispersed pigments in a polyol carrier. In typical embodiments, the resin blend will not contain a catalyst(s).

As mentioned above, layer 28 can be an N-polymer layer. This N-polymer can include a polymer having monomers that include nitrogen. Example N-polymers include, but are not limited to, polyureas, polyurethanes, and/or mixtures thereof. N-polymers can contain urea units (—N(C═O)N—), and/or urethane units (—NH—(C═O)—O—) connecting monomer or oligomers that may be carbon based. The N-polymer can be a polymer or a resin. Example N-polymers include but are not limited to Turbo-Liner 66, or Turbo-Liner MPL85, all available from Turbo Liner, Inc. of Kellogg, Id., USA, as well as the polyurea and/or polyurethane products available from Polycoat Products of Sante Fe Springs, Calif.

As discussed above, the second layer 28 may have different characteristics from the first layer 26 (and other layers 30 of the finished laminate discussed below), such as increased flexibility and elongation compared with the other layers 26, 30 of the laminate, to reduce, obstruct or prevent passage or replication of imperfections or features from subsequently-formed layers 30 to the first layer 26 and to assist with the absorption of energy and reduction in cracking and/or chipping within the first layer 26 resulting from cracks and/or chipping in one or more subsequent layers 30 or layer 26 and which assists with maintaining an exterior finish of mold quality. The second layer 28 may have substantially the same, less or greater hardness than the layers 26, 30 in example embodiments.

In embodiments where polyurea or a hybrid polyurea/polyurethane is utilized, the second layer 28 may be formed by spraying the polyurea or the hybrid polyurea/polyurethane at a pressure of approximately 1200-3500 psi and at a temperature of approximately 150-170 degrees F. for appropriate viscosity. In one embodiment where polyurethane is utilized, the second layer 28 may be formed by static/mechanical mixing. Other application methods may be used.

In FIG. 4D, one or more third layers 30 may be formed upon the second layer 28 to form additional layers of the finished laminate. The third layer(s) 30 may be utilized to provide the product with sufficient structural rigidity. As discussed above, the third layer(s) 30 may individually be a fiber-reinforced layer, such as fiberglass. Depending upon the product being manufactured, more than one fiber-reinforced layer may be provided depending upon the desired structural rigidity of the product. Example third layers 30 comprising fiberglass layers may individually include a fiberglass mat which may be a flat, coarse fabric composed of glass fibers, for example including chopped-strand mat, continuous strand mat, or surfacing veil. Example fiberglass cloths and mats are available from Fibre Glass-Evercoat a Division of Illinois Tool Works Inc. Alternatively, spray-applied glass may also be utilized.

A suitable resin, such as a polyester resin may be applied to layer 28 to support the subsequent application of fiber material. Alternatively, the fiber material may be applied before the polyester resin is applied. Following the application of the fiber material, additional polyester resin may be applied over the fibers and cured to form the third layer 30. This third layer 30 can be a composite of the fiber material and the resin. Examples of a suitable resin include a thermosetting or thermoplastic synthetic resin which may be made by esterification of polybasic organize acids with polyhydric acids with more specific examples including Dacron® and Mylar® polyesters which have high strength and excellent resistance to moisture and chemicals when cured. If more than one structural layer 30 is provided, the individual layers 30 may be formed in sequence with previously-formed layers achieving sufficient curing before additional layers 30 are formed or providing subsequent layers 30 upon a previous layer 30 before the previous layer 30 is cured in example embodiments.

In the example embodiments described above, the second and third layers 28, 30 are different compositions. Some aspects of the disclosure provide methods to achieve appropriate cross-linking of the second and third layers 28, 30 for product integrity. In one embodiment, the glass fibers and the resin of the third layer 30 are applied upon the second layer 28 while the second layer 28 is tacky which assists with the formation of a physical and/or chemical bonds of the second and third layers 28, 30 with one another. Furthermore, additional third layers 30 of glass matting or spray and resin may be formed depending upon the desired structural strength and application of the product being fabricated as mentioned above. A hand rolling process or other method may be utilized to remove air or imperfections from one or more of the layers 30. A vacuum process may also be utilized to form one or more layer of the product in one embodiment.

The three layer structure of layers 26, 28, and 30 are substantially carbon-based, containing nitrogen, and carbon-based, respectively. Conventional wisdom suggests that these layers would not adhere to each other due to their distinct chemical characteristics. However, the present disclosure demonstrates this is possible and provides a substantial benefit in article manufacturing processes. It has been demonstrated that layer 28 physically and/or chemically bonds with layers 26 and/or 30. Physically these layers may bond through commingling or integration with the interface between the layers interlocking the layers. Chemically, these layers may interact via cross-linking for example.

Referring to FIG. 4E, additional components 36, such as hardware, brace members or frame members may also be utilized and affixed to the first layer 26 and/or third layer(s) 30 before or after appropriate curing of the laminate. As discussed above, one or more components 36 may be polysterene, for example, available in pellet form as Total Polysterene from Total Petrochemicals USA, Inc. and sheet as Prime Impax Polysterene Sheet available from Primex Plastics Corporation. Components 36 may be brace or frame members and can also include other materials such as wood (e.g., teak or fir marine plywood available from Public Lumber Co. in one example where the product is a marine hull) or carbon steel. The components 36 may be affixed to cured structural layers 30, bonded to uncured structural layers 30 of the laminate or encapsulated by one or more structural layers 30 during fabrication of the laminate in example embodiments. In one example encapsulation embodiment, one or more structural layer 30 of the laminate may be formed and the component 36 may be positioned at an appropriate location adjacent to a structural layer 30, and thereafter, one or more additional structural layer 30 may be formed over the component 36 to encapsulate the component 36 within the laminate.

Referring to FIG. 4F, the fabricated laminate product may be removed from the mold 22 following appropriate curing of the layers 26, 28, 30 of the laminate according to one embodiment.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. A product wall composition comprising:
a polyester layer; and
an N-polymer layer coupled to the polyester layer.

2. The composition of claim 1 wherein the polyester layer comprises a polyester resin.

3. The composition of claim 1 wherein the N-polymer layer comprises one or both of polyurea and polyurethane.

4. The composition of claim 1 further comprising a mold having a surface coated with a release agent, the polyester layer contacting the release agent.

5. The composition of claim 4 wherein the mold is a boat hull mold.

6. The composition of claim 1 further comprising a fiber-reinforced layer coupled to the N-polymer layer.

7. The composition of claim 6 wherein the fiber-reinforced layer is a composite material comprising a polyester resin.

8. The composition of claim 6 further comprising a polystyrene layer coupled with the fiber-reinforced layer.

9. The composition of claim 1 wherein the polyester layer is one or both of physically and chemically bonded to the N-polymer layer.

10. The composition of claim 1 wherein the polyester layer is a gel coat.

11. A product wall comprising:
a gel coat layer;
a fiber-reinforced layer; and
a barrier layer intermediate the gel coat layer and the fiber-reinforced layer.

12. The wall of claim 11 wherein the barrier layer is immediately adjacent to the gel coat layer and the fiber-reinforced layer.

13. The wall of claim 11 wherein the barrier layer comprises a different composition than the gel coat layer and the fiber-reinforced layer.

14. The wall of claim 11 wherein the gel coat layer and the fiber-reinforced layer individually comprise polyester and the barrier layer comprises an N-polymer.

15. The wall of claim 14 wherein the N-polymer layer comprises one or both of polyurea and polyurethane.

16. The wall of claim 11 wherein the barrier layer has different physical characteristics than the gel coat layer and the fiber-reinforced layer.

17. The wall of claim 11 wherein the barrier layer has increased flexibility and elongation than the gel coat layer and the fiber-reinforced layer.

18. The wall of claim 11 wherein the fiber-reinforced layer comprises a fiberglass layer.

19. A molding process comprising:
forming an exterior finish layer within a mold;
forming a barrier layer over the exterior finish layer within the mold; and
forming a structural layer over the barrier layer within the mold.

20. The process of claim 19 wherein the exterior finish layer and the structural layer individually comprise polyester and the barrier layer comprises an N-polymer.

21. The process of claim 20 further comprising cross-linking the barrier layer with the exterior finish layer and cross-linking the structural layer with the barrier layer.

22. The process of claim 20 wherein the N-polymer layer comprises one or both of polyurea and polyurethane.

23. The process of claim 19 wherein the forming the structural layer comprises forming a fiber-reinforced layer.

24. The process of claim 23 wherein the forming the fiber-reinforced layer comprises applying fibers of the fiber-reinforced layer to the barrier layer while the barrier layer is tacky.
